(19) United States
(12) Patent Application Publication
(10) Pub. No.: US 2003/0074379 A1
(43) Pub. Date: Apr. 17, 2003

(54) Apparatus and method of predicting file download time based on historical data

(75) Inventors: Susann Marie Keohane, Austin, TX (US); Gerald Francis McBrearty, Round Rock, TX (US); Shawn Patrick Mullen, Buda, TX (US); Johnny Meng-Han Shieh, Austin, TX (US); James Stanley Tesauro, Austin, TX (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 09/974,988

(22) Filed: Oct. 11, 2001

(51) Int. Cl. G06F 12/00

(52) U.S. Cl. 707/205

(57) ABSTRACT

A method, system and apparatus for predicting a download time for a file using historical data are provided. A cross-reference table is used to archive an average time taken to download at least one file from a first computer system (e.g., a server) to a second computer system (e.g., a client). Whenever a file is to be downloaded from the first computer to the second sometime in the ufture, the size of the file is divided by the time stored in the table to predict how long it will take for the entire file to be downloaded.

### BACKGROUND OF THE INVENTION

1. Technical Field:

The present invention is directed to a communications network. More specifically, the present invention is directed to an apparatus and method of improving predictions of time needed to download a file based on previous interactions between a server and a client.

2. Description of Related Art:

The Internet is used for a variety of reasons. For example, a user may use the Internet to do research on a topic or to copy files from a computer system (e.g., a server) onto the user's own computer system (e.g., a client). The act of copying files from a server to a client is often referred to as downloading the files.

Ordinarily, when a file is being downloaded, an estimation of the time required to download the entire file is usually provided to the user. The estimation is usually provided in a form of a displayed status window. The status window, most of the times, contains a growing bar which the user may use to quickly judge how far along the transaction has progressed. Additionally, a countdown clock is displayed in the status window so the user can determine numerically the time remaining before the file download is completed.

Often times, when the file download is first initiated, a preliminary estimation is provided to the user. However, after the server and the client finally figure out the true data transmission rate, the estimation is generally readjusted. Obviously, the readjustment of the preliminary estimation takes sometime to occur and at times may be rather drastic. For example, it is not uncommon for the completion of a file download to be preliminarily estimated to be ten (10) minutes and then later readjusted to be thirty (30) minutes.

Some users sometimes may not have initiated the file download had they known the true amount of time it would take for the file download to be completed. Furthermore, when the true download time is known, these users may cancel the file download. Thus, the time spent between the initiation of the file download and its cancellation is time squandered that might have been better used for another task.

What is needed, therefore, is a better predictor of time required to download a file.

### SUMMARY OF THE INVENTION

The present invention provides a method, system and apparatus for predicting a download time for a file using historical data. A cross-reference table is used to archive an average time taken to download at least one file from a first computer system (e.g., a server) to a second computer system (e.g., a client). Whenever a file is to be downloaded from the first computer to the second sometime in the future, the size of the file is divided by the time stored in the table to predict how long it will take for the entire file to be downloaded.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 is a first representative cross-referencing table used by the present invention.

FIG. 5 is a second representative cross-referencing table used by the present invention.

FIG. 6 is a flow diagram of a process used by the present invention.

### DETAILED DESCRIPTION OF THE PREFERRED EMBODIMENT

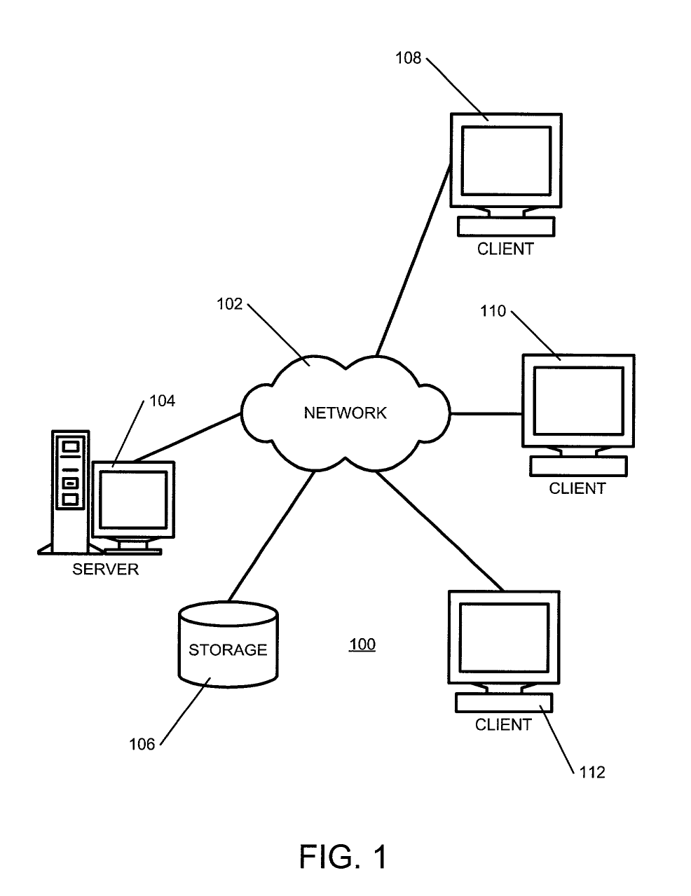

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

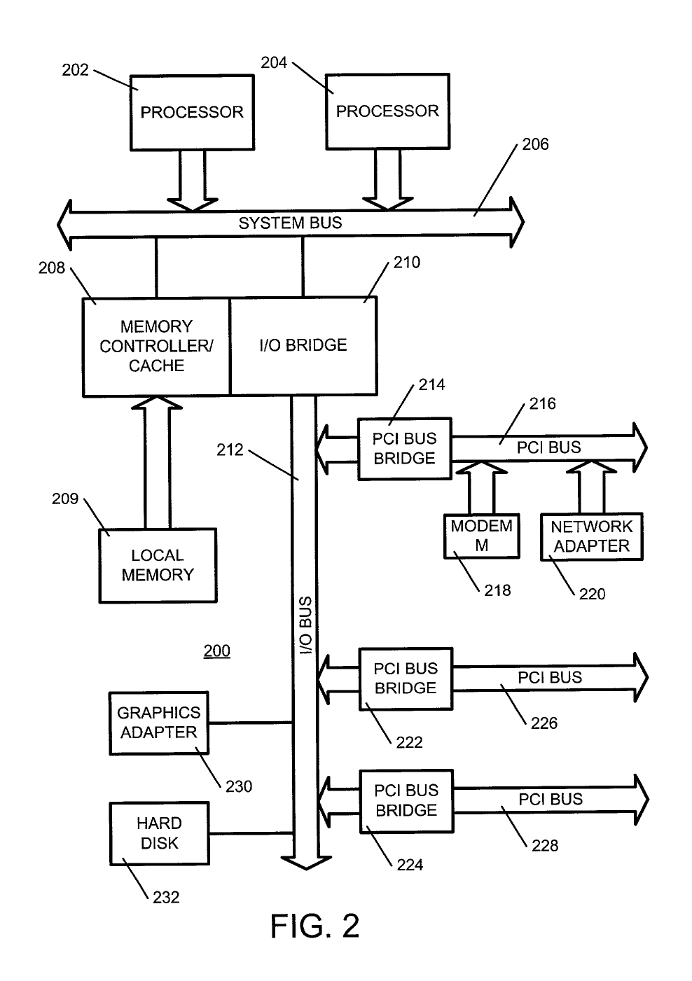

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pseries system, a product of International Business Machines Corporation in Armonk, New York, running the Advanced Interactive Executive (AIX) operating system or LINUX operating system.

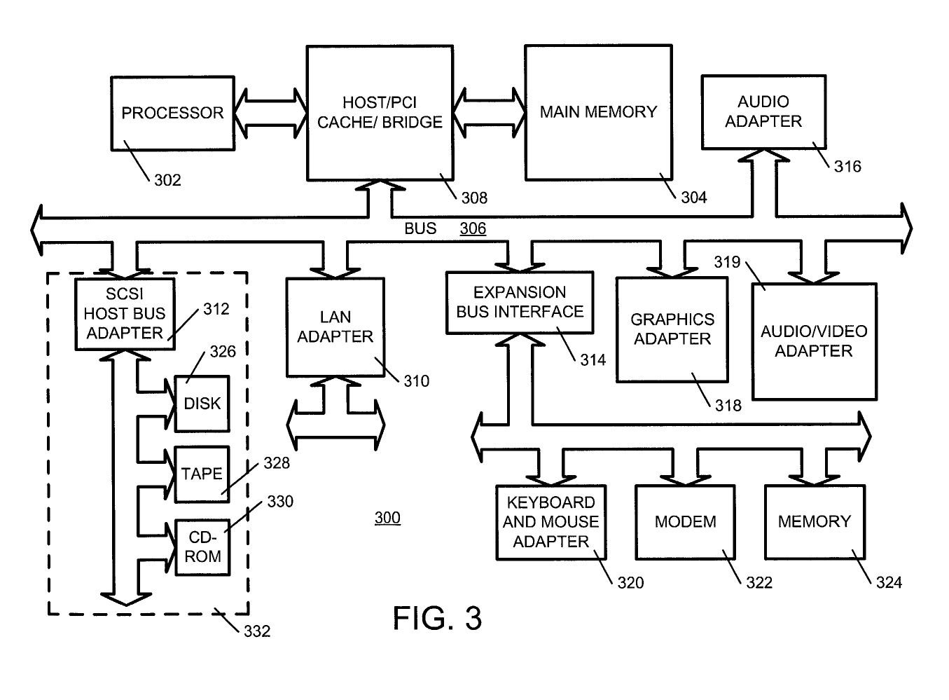

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus and method of improving predictions of file download time. The invention may be local to client systems 108, 110 and 112 of FIG. 1 or to the server 104 or to both the server 104 and clients 108, 110 and 112. Consequently, the present invention may reside on any data storage medium (i.e., floppy disk, compact disk, hard disk, ROM, RAM, etc.) used by a computer system.

Historically, it has always been difficult to predict the speed at which a file will be downloaded from a server to a client. The speed of a file download depends not only on the speed at which the server can process the file out and the speed at which the client can process the file in, it also depends on the speed at which the network (whether Internet, LAN, WAN, etc.) can convey the file to the client. The present invention relies on historical data analyses to predict the speed at which a file may be downloaded from a particular server to the client. To do so, the invention uses a cross-referencing table, preferably residing on the client, to archive the speed at which files were previously downloaded from a particular server to the client. In so doing, the invention takes into account the speed at which files were processed out by the server, processed in by the client and conveyed to the client by the network.

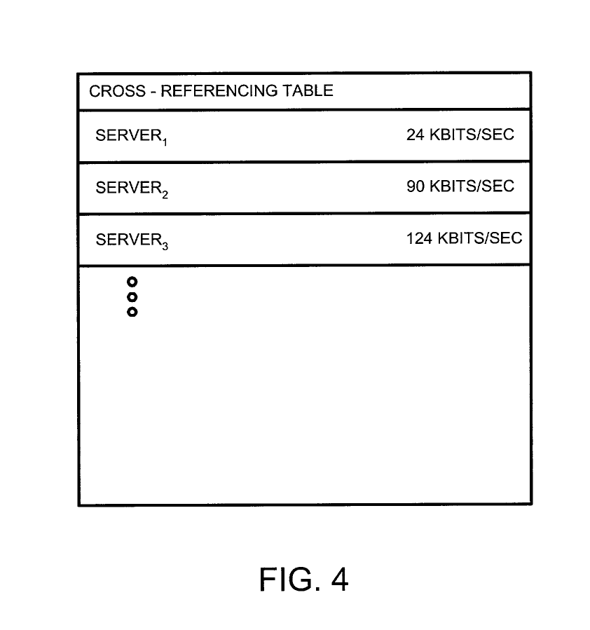

FIG. 4 displays the cross-referencing table. Server₁ is logged as having transmitted a file to the client at an average rate of 24 kbits/sec. Server₂ is entered as having transmitted a file at an average rate of 90 kbits/sec and server₃ at 124 kbits/sec. When files are downloaded, often times, the transmission rate during the file download varies. Thus, the average speed mentioned above is the average speed over the entire transmission.

If the client has downloaded files, say, from server₁ more than once, the invention may be implemented to archive the average of the average speed of all the file transmissions from server₁. Alternatively, the invention may be implemented to archive the last few file transmissions from the server to better predict future download times from the server. For example, suppose initially the client used to download files from server₁ at an average rate of 90 kbits/sec., then somehow in the recent past, the speed has slowed down to 24 kbits/sec. (this could be due to any number of reasons). If the average of the average speed of all file downloads from server₁ is taken into account, the speed will be skewed upward (i.e., predicted download time may be much less than actual download time). If instead, the last few downloads are archived and analyzed each time a client is to download a file from the server, the client may come up with a more realistic prediction.

In any case, the present invention may be implemented such that particular programmed keystrokes or a key from the mouse can activate the invention. Suppose for example, the right mouse key has been programmed to activate the invention. Then, before downloading a file if the user right clicks on the file to download, the table will be consulted to determine whether files have been downloaded from that server or web site before (i.e., the client will determine whether there is an entry or entries for that server in the table). If so, the size of the file (which is usually provided) will be divided by the average speed archived to arrive at a predicted download time. The predicted time will then be displayed to the user. At this point, if the user wants to download the file the user may initiate the download.

In the case where no files have ever been downloaded from a particular server by the client before, no historical data will be available. If a user then right clicks on the mouse, “no available data” may be displayed.

When a user actually initiates a file download, progress status bar and countdown clock will be displayed as usual. After the download is completed, the average speed of the download (i.e., time from start to finish of the download) will be stored in the table for future reference.

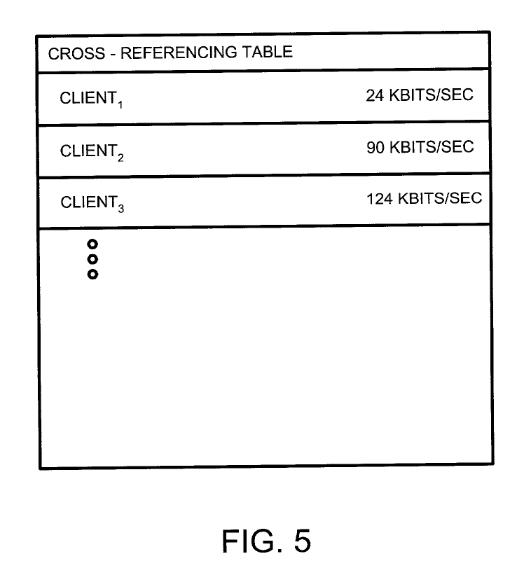

The invention has been described as residing on the client. However, it may reside on the server as well. That is, the server may keep a cross-referencing table in which client systems are cross-referenced with download times. FIG. 5 depicts such table.

In this case, next to each downloadable file, there may be an icon that a user may assert to get the predicted download time. If the user asserts the icon, the server will consult the reference table to determine whether the client system has downloaded files from the server before. If so, the server will divide the size of the file by the archived transmission rate and displays the estimated download time. As mentioned above, if a client has never downloaded files from the server before “no data available” may be displayed.

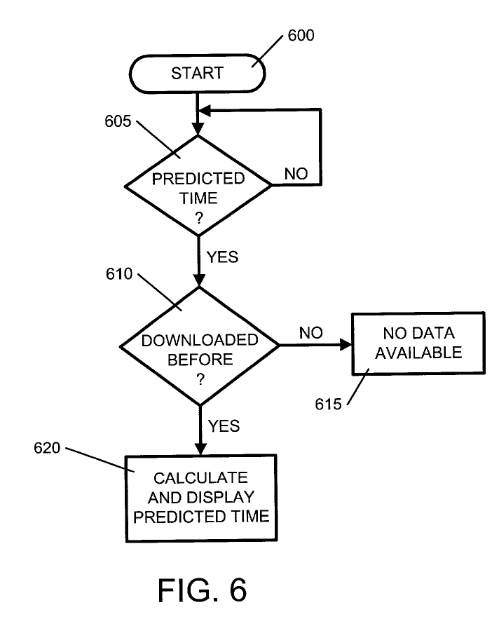

FIG. 6 is a flow diagram of a process used by the invention. The process starts as soon as a Web browser is activated (step 600). A check is continuously being made as to whether a user wants a predicted file download time. This may be when the user right clicks on a mouse while the mouse is on a downloadable file (in the case where the invention resides on a client and the right mouse button is programmed to provide predicted file download time) or when the user asserts the predicted time icon next to the downloadable file (in the case where the invention resides on a server). Note that the invention may reside on both a client and a server when a file is to be downloaded.

If a predicted time is requested, then a check is made as to whether there have been files downloaded from the server to the client. If not, a “no data available” may be displayed (steps 605, 610 and 615). If a file or files have been downloaded before, a predicted download time based on the size of the file to be downloaded and the archived time of previous downloads will be calculated. When done, the predicted download time will be displayed (steps 605, 610 and 620).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of predicting a file download time before said file is being downloaded, said file having a size and being downloaded from a first computer system to a second computer system, said method comprising the steps of:
calculating the predicted download time using the size of the file and at least a historical download time between the first computer system and the second computer system; and
displaying the calculated time.

2. The method of claim 1 wherein said historical download time is an average time taken to download a plurality of files.

3. The method of claim 1 wherein said historical download time is based on an analysis of most recent download times.

4. The method of claim 1 wherein the predicted download time is calculated by the first computer system.

5. The method of claim 1 wherein the predicted download time is calculated by the second computer system.

6. A computer program product stored on a computer readable medium for predicting a file download time before said file is being downloaded, said file having a size and being downloaded from a first computer system to a second computer system, said computer program product comprising:
code means for calculating the predicted download time using the size of the file and at least a historical download time between the first computer system and the second computer system; and
code means for displaying the calculated time.

7. The computer program product of claim 6 wherein said historical download time is an average time taken to download a plurality of files.

8. The computer program product of claim 6 wherein said historical download time is based on an analysis of most recent download times.

9. The computer program product of claim 6 wherein the predicted download time is calculated by the first computer system.

10. The computer program product of claim 6 wherein the predicted download time is calculated by the second computer system.

11. An apparatus for predicting a file download time before said file is being downloaded, said file having a size and being downloaded from a first computer system to a second computer system, said apparatus comprising:
means for calculating the predicted download time using the size of the file and at least a historical download time between the first computer system and the second computer system; and
means for displaying the calculated time.

12. The apparatus of claim 11 wherein said historical download time is an average time taken to download a plurality of files.

13. The apparatus of claim 11 wherein said historical download time is based on an analysis of most recent download times.

14. The apparatus of claim 11 wherein the predicted download time is calculated by the first computer system.

15. The apparatus of claim 11 wherein the predicted download time is calculated by the second computer system.

16. A computer system used for predicting a file download time before said file is being downloaded, said file having a size and being downloaded from another computer system to the computer system, the computer system comprising:
a memory to store code data; and
a processor for processing said code to calculate the predicted download time using the size of the file and at least a historical download time between the first computer system and the second computer system, and to display the calculated time.

17. The computer system of claim 16 wherein said historical download time is an average time taken to download a plurality of files.

18. The computer system of claim 16 wherein said historical download time is based on an analysis of most recent download times.

19. The computer system of claim 16 wherein the predicted download time is calculated by the computer system.

20. The computer system of claim 16 wherein the predicted download time is calculated by the other computer system.
